(19) United States
(12) Patent Application Publication
(10) Pub. No.: US 2006/0037960 A1
(43) Pub. Date: Feb. 23, 2006

(54) Paint tray cover and liner membrane

(76) Inventor: Wallace B. Rosa, Morton, WA (US)

Correspondence Address: DEAN A. CRAINE, P.S.;SUITE 140, 400-112TH AVENUE, BELLEVUE, WA, 98004, US

(21) Appl. No.: 11/209,210

(22) Filed: Aug. 19, 2005

Related U.S. Application Data
(60) Provisional application No. 60/603,314, filed on Aug. 20, 2004.

(51) Int. Cl. B44D 3/12

(52) U.S. Cl. 220/495.02; 15/257.06

(57) ABSTRACT

A paint tray membrane designed to be used as a flexible paint-impervious and paint-solvent-resistant liner or cover for a rectangular shaped paint tray. The membrane includes an adhesive formed on its bottom surface that removably attaches the membrane to the top surface of a paint tray during use. The adhesive has sufficient adhesion properties to that the membrane forms a tray-like structure that conforms to the paint tray and does not dislodge from the paint tray when used with roller. The membrane is designed to be easily removed from the paint tray to form a bag structure to allow unused paint to be pour back into the original paint can or discarded. The membrane is also sufficiently flexible to be stretched across the top surfaces of a paint tray to cover the paint and prevent drying out. A plurality of membranes are designed to be dispensed together in sheets vertically stacked, or tightly folded for compact storage.

This is a utility patent application, which claims the benefit of the U.S. provisional patent application (Ser. No. 60/603,314), filed on Aug. 20, 2004.

### BACKGROUND OF THE INVENTION

1. Field of the Invention

This invention pertains to paint tray liners and covers, and more particularly to membranes that can be used either as a disposable paint tray liner or as a cover that extends over the upper edges of the paint tray to prevent paint from drying out inside the paint tray.

2. Description of the Related Art

Paint trays are available in different shapes and sizes and must always be cleaned after use. Some paint trays are made of inexpensive material and designed to be discarded after a single use. One drawback with disposable paint trays is that they tend to be flimsy and difficult to use without spilling paint. They are also difficult to move and use on a stepladder where they are unsupported.

Plastic liners for paint trays are common. The main advantages of plastic liners are that they are less expensive than rigid, metallic paint trays and may be discarded after use. A disadvantage is that they rarely closely fit the numerous designs of paint trays and being semi-rigid are fragile and bulky,

Some rigid paint trays are sold with covers that prevent paint drying in the paint tray or on brushes when temporarily stored in the paint tray. Unfortunately, paint trays with covers cannot be used with plastic liners, and are specific to a single design of paint tray.

What is needed is a flexible membrane that can be used as either a liner or a removable cover for a standard paint tray and adaptable to many shapes and sizes. Such a membrane should be easy to mold inside the paint tray, does not move or dislodge from the paint tray when used with a roller, and should be easy to remove from the paint tray with little or no spilling. Such membranes should be able to be used as a cover for a paint tray used with or without a plastic liner or when a paint brush or roller is stored inside the paint tray. Such membranes should also be dispensed in a compact configuration for economic distribution and shipping and minimal storage and shelf space.

### SUMMARY OF THE INVENTION

The above stated objects are met by the paint tray membrane disclosed herein, designed to be used as a flexible liner designed to be manually molded to conform closely to the inside surfaces of a paint tray or used as a cover that extends over the top edges of a paint tray.

The membrane is made of a thin film-like material that is air and paint impermeable. During use, the membrane is sufficiently flexible to be manually molded to conform and cover the bottom, opposite sidewall, opposite ends of paint tray. When the painting task is completed, the membrane is folded upward to create a bag structure that enables excess paint to be transferred back to the paint container or discarded into a suitable discharge container.

The membrane is sufficient in length and width to fit inside the paint tray and cover the bottom surface, the front and back surfaces and the opposite sides surfaces. The membrane is also sufficient in width and length to extend fully across the top edges of the paint tray and function as a cover.

On one embodiment, three, transversely aligned strips of adhesive that applied to the bottom surface of the membrane which adhesively attaches the bottom surface of the membrane to the top and opposite side surfaces of the paint tray. During use, the three strips of adhesive securely hold the membrane in place inside the paint tray when a roller is used inside the paint tray. The adhesive used has sufficiently reversible bond to allow the membrane to be easily removed from the paint tray during clean up. When an air sensitive adhesive is used or when an adhesive is used that might permanently bond stacked sheets together, each adhesive strip is covered by an optional, removable backing sheet to prevent the adhesive strips from drying out and to prevent stacked membranes from permanently bonding together.

In another embodiment, an adhesive layer that extends substantially the entire bottom surface of the membrane is disclosed. An optional backing sheet may also be used to prevent the adhesive drying out or the sheets from sticking together.

In the preferred embodiment, a plurality of membranes are stacked into a compact configuration. A portion or all of each adhesive may be exposed to enable the membranes to temporarily hold them in a stacked configuration.

### DESCRIPTION OF THE DRAWINGS

FIG. 1 is a perspective view of a paint tray with the membrane used as a liner.

FIG. 2 is a perspective view of a paint tray with the membrane used as a cover.

FIG. 3 is an exploded, perspective view of the first embodiment of the membrane positioned above the paint tray.

FIG. 4 is a top plane view of the first embodiment of the membrane placed over a standard paint tray.

FIG. 5 is a perspective view of the membrane used as a liner inside the standard paint tray.

FIG. 6 is a perspective view of the membrane being used as a cover on a standard paint tray with a paint roller stored therein.

FIG. 7 is a side elevation view of another paint tray developed by the inventor with the membrane being used as a cover.

FIGS. 8 and 9 are perspective views of a plurality of membranes dispensed in a stacked configuration with removable layers positioned between the membranes.

FIG. 10 is a side elevational view of a membrane folded into a bag configuration.

### DESCRIPTION OF THE PREFERRED EMBODIMENT(S)

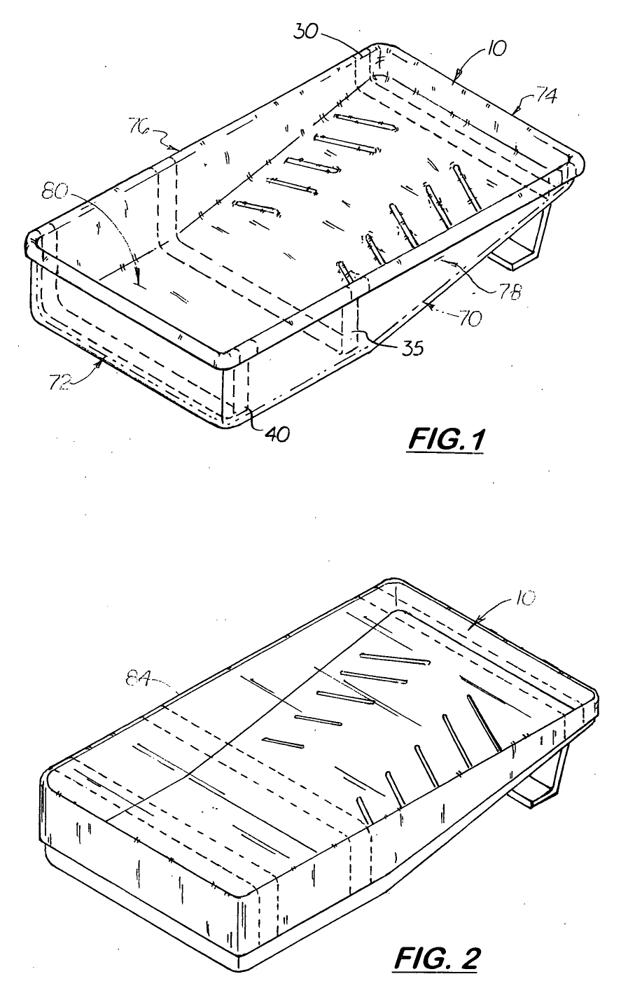

Shown in the accompanying Figs there is a flexible membrane 10 designed to be manually molded to conform closely to the inside surfaces 72-80 of a paint tray 70 as shown in FIG. 1 or used as a cover that extends over the top edges 84 of a paint tray 70 as shown in FIGS. 2 and 7.

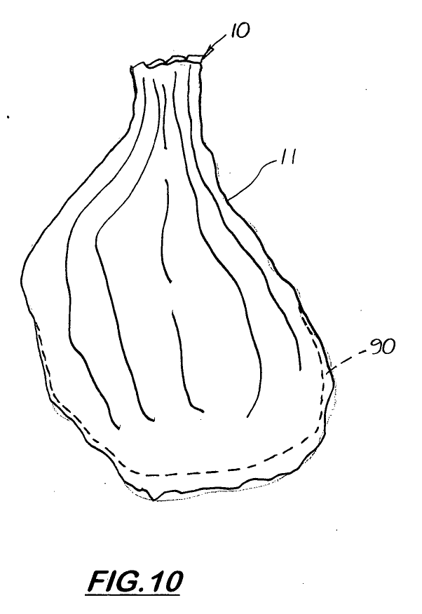

The membrane 10 is made of a thin film-like material that is air and paint impermeable. During use, the membrane 10 is sufficiently flexible to be manually molded to conform and cover the inside surfaces 72-80 of the front wall, rear wall, opposite sidewalls, and bottom, respectively, on a standard, rectangular paint tray 70. When the painting task is completed, the membrane 10 is folded into a bag structure 11 shown in FIG. 10 that is used to transport excess paint 90 back to the paint container or discarded into a suitable discharge container.

The membrane 10 is sufficient in length and width to fit inside the paint tray 70 and cover the inside surfaces 72-80. The membrane 10 is also sufficient in length and width to extend fully across the top edges 84 of the paint tray 70 and function as an airtight seal.

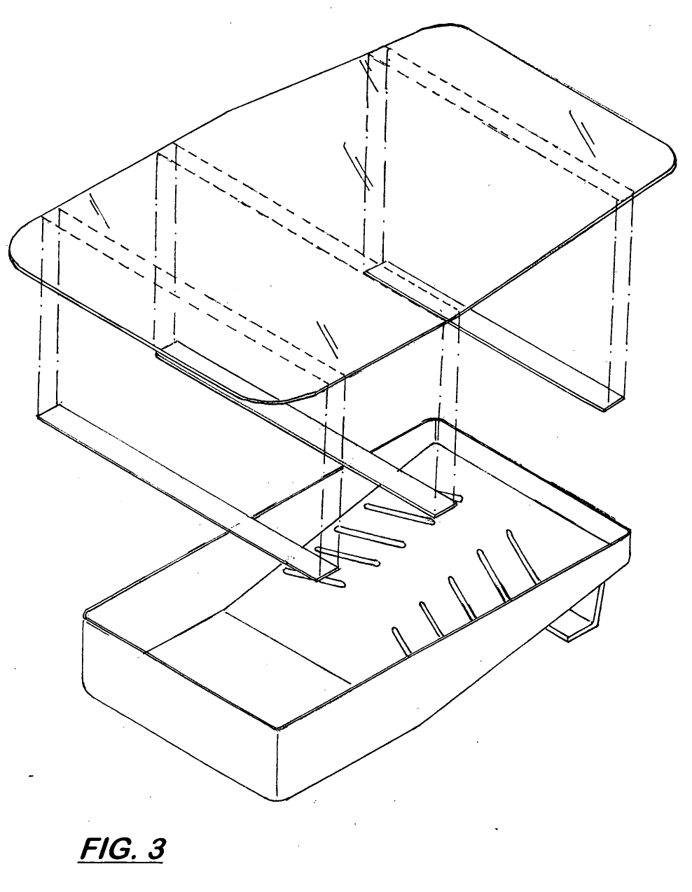

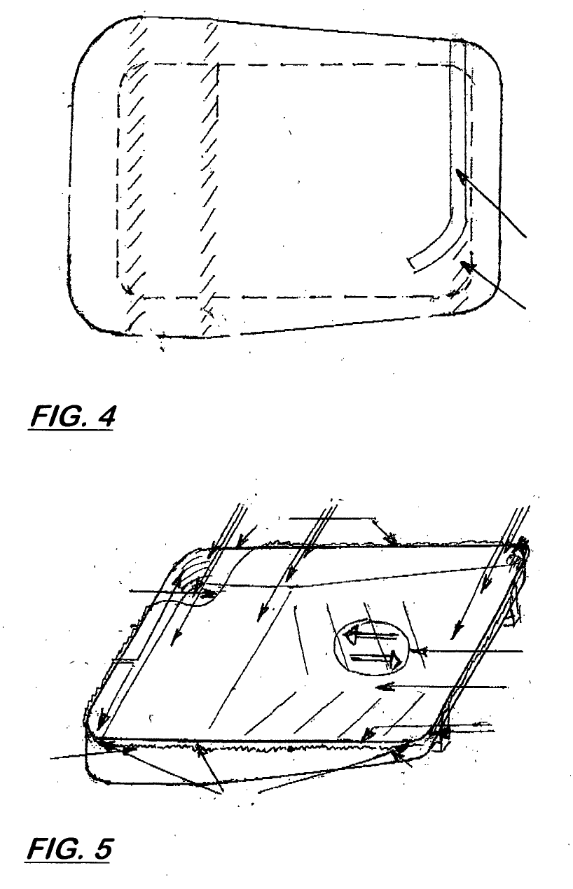

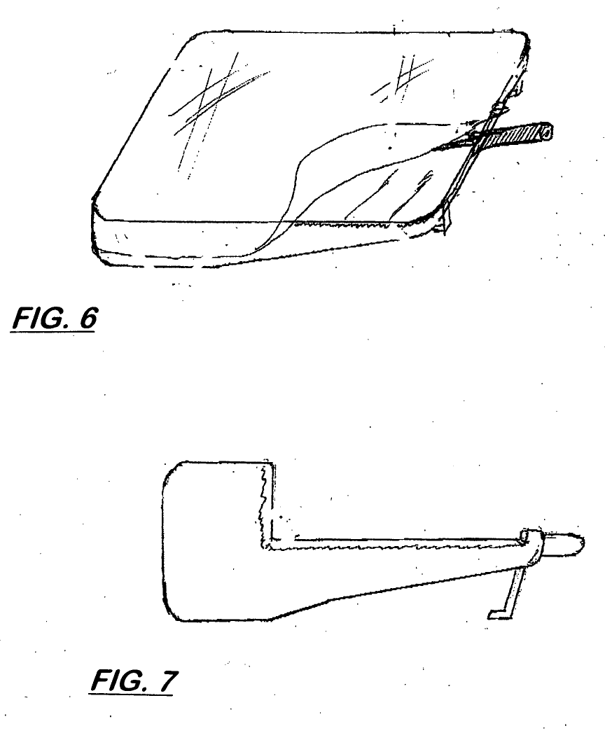

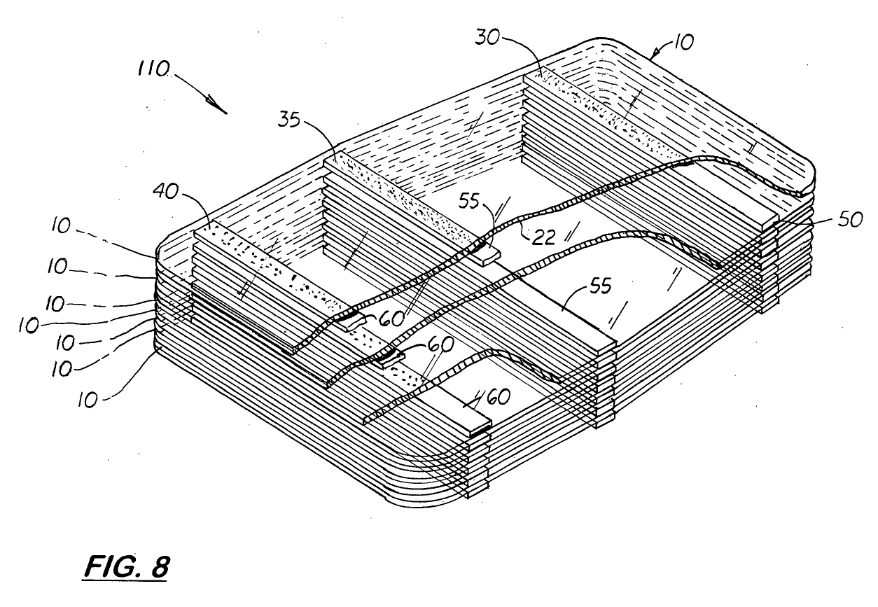

On one embodiment shown in FIGS. 1-4, three transversely aligned strips of adhesive, denoted 30, 35 and 40, respectively, are applied to the bottom surface 22 of the membrane 10 which adhesively attach to the two opposite side surfaces 76, 78 and to the bottom surface 80 of the paint tray 70. During use, the three strips of adhesive 30, 35, 40 securely hold the membrane 10 in place inside the paint tray 70 when a roller is used inside the paint tray 70 as shown in FIG. 5. The adhesive used on each adhesive strip 30, 35, 40 is sufficiently weak to allow the membrane 10 to be easily removed from the paint tray 70 during clean up. When an air sensitive adhesive is used or when an adhesive is used that attaches to stacked configurations shown in FIG. 8, each adhesive strip 35, 40, 45 is covered by a removable backing sheet 50, 55, 60, respectively, to prevent the adhesive strips 35, 40, 45 from drying out or from sticking together when a plurality of membranes stacked together in a vertical pile as shown in FIG. 8.

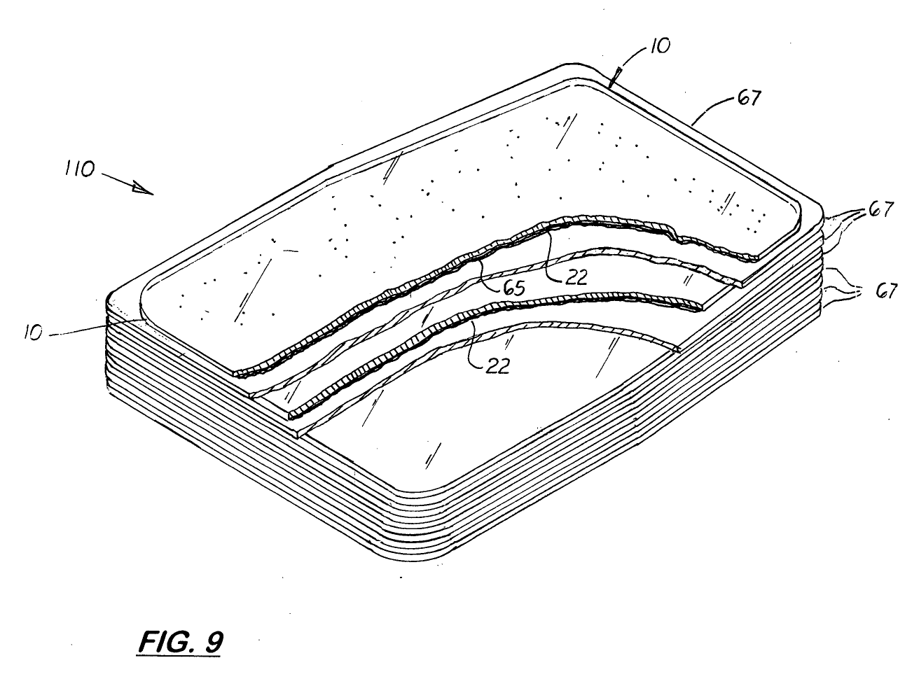

In another embodiment shown in FIG. 9, one continuous adhesive layer 65 is formed over the bottom surface 22 of the membrane 10. An optional removable backing sheet 67 is used to prevent the adhesive layer 65 from drying out or the sheets from stacking together as shown in FIG. 9

As shown in FIGS. 8 and 9, in the preferred embodiment, a plurality of membranes 10 are dispensed into a compact stack configuration, designated as 110. A portion of some of the adhesive layers 30, 35, 40 or 65 may be exposed to enable the membranes 10 to be adhesively attached to temporarily hold them in a stacked configuration.

As shown in FIGS. 1 and 2, the adhesive layers 35, 40, 45 or 65 are aligned on the membrane 10 to hold the membrane 10 in place against forces of normal use parallel to the surface of the paint tray 70, particularly the repeated use of a paint roller in directions up and down the unloading deck of the paint tray 70 as shown in FIG. 5. A second consideration of this adhesive pattern is that it holds the membrane 10 itself in place against the surface of the paint tray 70 so that non-adhering excess membrane material does not intrude into the working area of the paint tray and interfere with use. This second consideration includes especially the inside vertical corners 10 of the paint tray 70 where the membrane 10 folds will be held against the corners and also includes the upper edges of the paint tray 70 where excess membrane overlap. A third consideration of this adhesive pattern is that it be elegantly minimized in extent to accomplish its desired function at minimal manufacture cost and with the least effort of user application to the paint tray 70.

The membrane 10 is selected according to resistance to common paint solvents, or can be selected for selective resistance to certain specialized or troublesome solvents. Membrane 10 may also be selected according to other traits such as surface friction for proper engagement of a paint roller on the unloading deck of the paint tray 70 during painting use. Membrane thickness chosen varies within flexibility parameters of a given material to allow efficient folding at the critical bonding areas and yet not allow excessive-play of membrane material at the outer paint tray lip or between adhesive pattern areas in embodiment 1 or 3. Membrane thickness of chosen material also varies within strength parameters to allow a spent membrane liner together with unused paint to be lifted from paint tray 5,18 without bursting and spillage of paint.

In the preferred embodiment, the membrane 10 has a thickness of 0.5 to 5 mils. The adhesive used in the surfaces 35, 40, 45 and 65 is similar in function to the adhesive used on 3-M Manufacturing, Inc and their Post-It note pad products.

In all three embodiments the adhesive is selected according to compatibility with membrane material chosen, and with the various materials that comprise common paint trays including but not limited to metal, polyethylene, and nylon, and with consideration that it be reasonably repositionable at will of user, but will not slip parallel to paint tray surface when applied.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A combination liner or cover for a paint tray, comprising:
a. a flexible membrane sufficiently wide and long to form a tray like structure that covers the bottom surface, the front and end surfaces, and the two opposite surfaces of a paint tray, said membrane being made of moldable material enabling said membrane to be dispensed in a sheet structure that is manually molded into a tray-like structure that conforms and covers the inside surfaces of said paint tray, said membrane being made of air and paint impermeable material; and,
b. means for temporarily attaching said membrane inside said paint tray and attaching said membrane in an extended position over the top edges of said paint tray.

2. The membrane as recited in claim 1, wherein said means for attaching said membrane inside said paint tray and attaching said membrane in an extended position over the top edges of said paint tray are at least two transversely aligned adhesive strips attached to the bottom surface of said membrane.

3. The membrane, as recited in claim 2, further includes a removable backing layer placed over each said adhesive strip to prevent each said adhesive strip from drying or attaching to a lower membrane when stacked together.

4. The membrane as recited in claim 1, wherein said means for attaching said membrane inside said paint tray and attaching said membrane in an extended position over the top edges of said paint tray is an adhesive layer attached to said bottom surface of said membrane.

5. The membrane, as recited in claim 4, further including a removable backing layer placed over said adhesive strip to prevent said aid adhesive strip from drying or attaching to a lower membrane when stacked together.

6. A disposable paint tray membrane product, including a plurality off flexible membranes dispensed in a stacked configuration, each said flexible membrane being sufficiently wide and long to form a tray like structure that covers the bottom surface, the front and end surfaces, and the two opposite surfaces of a paint tray, said membrane being made of moldable material enabling said membrane to be dispensed in a sheet structure that is manually molded into a tray-like structure that conforms and covers the inside surfaces of said paint tray, said membrane being made of air and paint impermeable material, and, means for temporarily attaching said membrane inside said paint tray or attaching said membrane in an extended position over the top edges of said paint tray.

7. A painting system comprising:
a. a rectangular paint tray; said paint tray including a bottom surface, a front and back surface, and two opposite side surfaces;
b. at least one flexible membrane sufficiently wide and long to form a tray-like structure that covers said bottom surface, said front and end surfaces, and said opposite side surfaces of said paint tray, said membrane being made of moldable material enabling said membrane to be dispensed in a sheet structure that is manually molded into a tray-like structure that conforms and covers the inside surfaces of said paint tray, said membrane being made of air and paint impermeable material; and,
c. means for temporarily attaching said membrane inside said paint tray and attaching said membrane in an extended position over the top edges of said paint tray.
